(19) United States
(12) Patent Application Publication
(10) Pub. No.: US 2009/0002877 A1
(43) Pub. Date: Jan. 1, 2009

(54) MEDIA PRESERVATION FOR INFORMATION TRANSDUCING DRIVE

(75) Inventor: William Edward Dunphy, Erie, CO (US)

Correspondence Address: NIXON & VANDERHYE, PC, 901 NORTH GLEBE ROAD, 11TH FLOOR, ARLINGTON, VA, 22203, US

(73) Assignee: Tandberg Data Corporation, Boulder, CO (US)

(21) Appl. No.: 12/144,867

(22) Filed: Jun. 24, 2008

Related U.S. Application Data
(60) Provisional application No. 60/946,528, filed on Jun. 27, 2007.

(51) Int. Cl. G11B 5/584

(52) U.S. Cl. 360/77.12

(57) ABSTRACT

An information transducing drive performs information transducing operations with respect to transducable media. In an example embodiment the drive comprises an information transducer (30); a cartridge handler (32); a media transport system (35); and a controller (36). The transducer (30) is configured to perform the information transducing operations with respect to the media (24). The cartridge handler (32) opens a lid (28) of the cartridge (26) and selectively extracts the media at least partially from the cartridge and selectively retracts the media into the cartridge. The media transport system (35) transports the media extracted from the cartridge in a transport path whereby the transducer can perform the information transducing operations with respect to the media. The controller (36) executes a media preservation mode by directing return of the media to the cartridge whereby substantially all user data eligible segments of the media are unexposed while the drive appears on-line with respect to further transducing operations.

This application claims the priority and benefit of U.S. Provisional Patent Application 60/946,528 filed Jun. 27, 2007, entitled “MEDIA PRESERVATION FOR TAPE DRIVE”, which is incorporated herein by reference in its entirety.

### BACKGROUND

I. Technical Field

This invention pertains to recording information on and reproducing information from magnetic tape.

II. Related Art and Other Considerations

Due to the uncontrollable nature of customer environments, a magnetic tape drive is exposed to many environmentally produced contaminants (dust, dirt, chemical). These contaminants are drawn through the tape drive in various ways such as by (1) server produced air flow, (2) external enclosure air flow and/or (3) air flow produced by the tape drive itself (e.g., for tape drives having an internal fan). This constant flow of contaminants is not especially noticeable when the tape drive is in operation due to the constant movement of tape. However, when the tape drive sits quiesced for a long period of time (waiting on a scheduled backup), the accumulation of debris which occurs on the exposed magnetic tape surface can cripple the drives ability to write/read over the exposed region resulting in a failed backup/restore experience for the customer.

One example tape drive is that known as the VXA drive which is manufactured and marketed by Tandberg Data.

What is needed, therefore, and an object of the present invention, are techniques, methods, and apparatus for preserving magnetic tape media, enhancing media reliability, and preserving a tape drive's write/read performance in non-pristine operating environments.

### BRIEF SUMMARY

In its various aspects, the technology described herein concerns an information transducing drive, a software program product executed by a processor of the drive, and method of operating an information transducing drive. The technology particular pertains to an information transducing drive that operates in a media preservation mode, and/or a software program product that facilitates operation of an information transducing drive in the media preservation mode.

Thus, in one of its aspects the technology concerns an information transducing drive which performs information transducing operations with respect to transducable media. In an example embodiment the drive comprises an information transducer; a cartridge handler; a media transport system; and a controller. The transducer is configured to perform the information transducing operations with respect to the media. The cartridge handler opens a lid of a cartridge and selectively extracts the media at least partially from the cartridge and selectively retracts the media into the cartridge. The media transport system transports the media extracted from the cartridge in a transport path whereby the transducer can perform the information transducing operations with respect to the media. The controller executes a media preservation mode by directing return of the media to the cartridge whereby substantially all user data eligible segments of the media are unexposed while the drive appears on-line with respect to further transducing operations (e.g., subsequent potential transducing operations).

The media preservation mode can be performed by or initiated by the controller upon any suitable triggering event, such as (for example) when the drive has been left quiesced for a predetermined period of time (e.g., no recording or reproducing operations prompted or requested by a host device served by the information transducing drive). In an example implementation, the controller determines that/when the media preservation mode should commence.

In being “unexposed” is meant that recording/reproducing surfaces of the segments of the media are covered, e.g., by other layers of media (wrapped on reels or in a pack, in the case of the media being magnetic tape, for example) or by the cartridge, etc., and thereby sheltered from potential contaminates.

In an example embodiment the information transducing drive further comprises an interface through which a command for transducing operations (e.g., a recording operation or a reproducing operation) is received. When the media preservation mode is performed the interface is essentially oblivious to execution of the media preservation mode. That is, no information indicative of the execution of the media preservation mode is transmitted through the interface.

In an example mode, the media preservation mode comprise an initiation phase for sheltering or covering substantially all the user data eligible segments of the media. The initiation phase is commenced at an appropriate time, such as when the drive has been left quiesced for a predetermined period of time (e.g., when a host or user device connected to the information transducing drive has not issued a transducing command [e.g., for reproducing from the media or recording to the media] for a predetermined period of time). The media preservation mode also comprises a termination phase wherein the controller returns the media to an appropriate transducable position when the controller realizes that the host or user device has or is ready to issue another transducing command. If, in the course of performing the initiation phase, the controller realizes before completion of the initiation phase that the host or user device has or is ready to issue another transducing command, the media preservation mode can switch to an interruption phase.

In an example embodiment, in an initiation phase of the media preservation mode the controller determines a pre-media preservation mode return position of the media. The pre-media preservation mode return position is a physical position of the media eligible for a post-media preservation mode transducing operation. The controller then directs the cartridge handler to unload the media from the media transport path and to retract the media into the cartridge whereby substantially all the user data eligible segments are unexposed. The controller then directs the cartridge handler to close a lid on the cartridge.

In the termination phase the controller returns the media to an appropriate transducable position when the controller realizes that the host or user device has or is ready to issue another transducing command. First actions included in the termination phase include determining/detecting that the further transducing operations should occur. Further actions comprise directing the cartridge handler to open the cartridge lid, extract the media from the cartridge, and to re-load the media into the media transport path. The termination phase also includes directing the media transport system to position the media so that the transducing operations can continue at the pre-media preservation mode return position.

If, in the course of performing the initiation phase, the controller realizes before completion of the initiation phase that the host or user device has or is ready to issue another transducing command, the media preservation mode can switch to an interruption phase.

In the interruption phase of the media preservation mode is invoked when the controller detects or realizes that, before completion of the initiation phase, the host or user device has or is ready to issue another transducing command. For example, if the controller determines or realizes that further transducing operations should occur before the user data segments of the media are sheltered or before the media is retracted into the cartridge, in the interruption phase the controller directs the media transport system to position the media so that the transducing operations can continue at the pre-media preservation mode return position.

In a variation of the example embodiment, the lid of the cartridge is not closed in the initiation phase, and the controller directs the return of the media to the cartridge whereby only a segment of the media ineligible for transducing of user data is exposed through the cartridge lid. Preferably, the segment of the media ineligible for user data comprises a predetermined portion of the media proximate one of a physical beginning of the media and a physical end of the media. In an example implementation of this variation, the controller directs the media transport system to move the media to expose a random portion of the segment of the media ineligible for transducing of user data. Advantageously, during other (e.g., subsequent) possible executions of the media preservation mode, numerous positions of the ineligible segment are exposed so that no particular position on the ineligible segment becomes repeatedly exposed to potential contaminates.

In an example embodiment, the information transducing drive comprises a drum upon which the transducer is mounted, such as a rotating scanner employed in a helical scan information transducing drive, for example. In such drum embodiment, the controller can initiate the media preservation mode by performing the further act of terminating rotation of the drum.

In another one of its aspects the technology concerns a software program product comprising coded instructions stored on a program media. When executed by a processor of a drive which performs information transducing operations with respect to transducable media, the software program product directs return of the transducable media to a cartridge whereby substantially all user data eligible segments of the media are unexposed or sheltered while the drive appears on-line with respect to further transducing operations. In its various implementations, the software program product can facilitate the example embodiments and implementations described above.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a schematic view of an example embodiment of an information transducing drive suitable for operating in a media preservation mode.

FIG. 2 is a flowchart showing example, basic aspects of a media preservation mode.

FIG. 3 is a flowchart showing example, basic acts or steps performed in conjunction an example embodiment of an initiation phase and a termination phase of an example media preservation mode.

FIG. 4 is a flowchart showing example, basic acts or steps performed in conjunction an example embodiment of an interruption phase of the example media preservation mode of FIG. 3.

FIG. 5 is a flowchart showing example, basic acts or steps performed in conjunction with a variation of the embodiment of the media preservation mode of FIG. 3.

FIG. 6 is a diagrammatic view showing an example format of media, including both segments of media which are ineligible for transducing of user data and segments of media which are eligible for transducing of user data.

FIG. 7 is a plan diagrammatic view of a cartridge having its lid open and thereby exposing a segment of media which are ineligible for transducing of user data.

FIG. 8 is a diagrammatic view showing a user data transducing ineligible segment of media and randomly placed exposure windows.

FIG. 9 is a flowchart showing example, basic acts or steps performed in conjunction with a rotating drum variation of the embodiment of the media preservation mode of FIG. 3.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

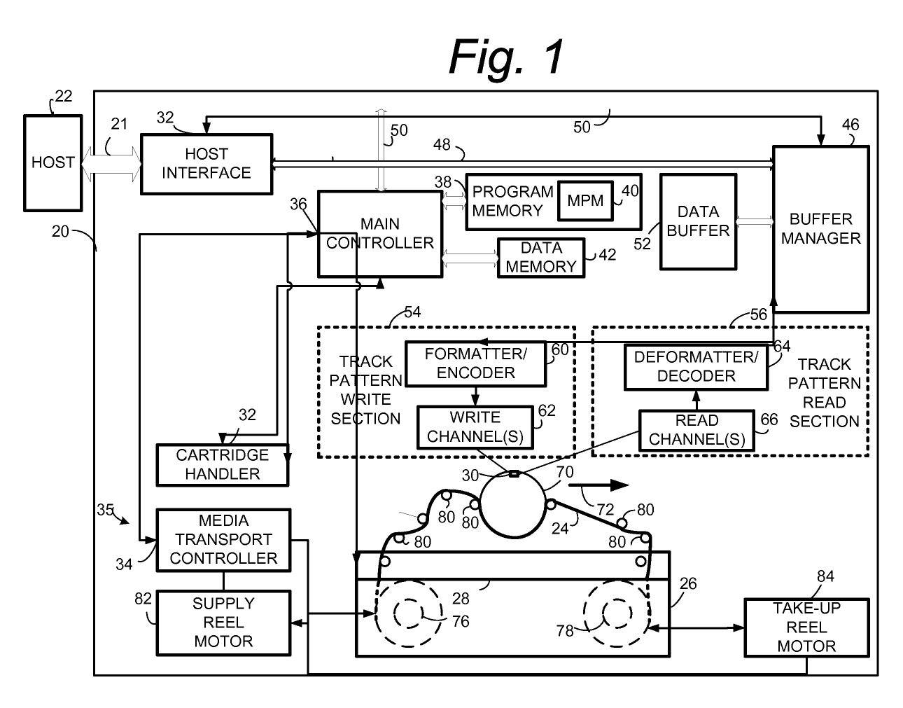

FIG. 1 illustrates an example, non-limiting, information transducing drive 20 of a representative type suitable for performing or operating in a media preservation mode. Drive 20 is connected to host device 22 by interface bus 23. The host device 22 can take the form of any type of electronic information processing system which has a need to store or retrieve information on an external memory device. The external memory device is of a type which employs the information transducing drive 20 through which information is recorded to (written on) or reproduced (e.g., read) from a transducable information storage media 24.

FIG. 1 depicts the information storage media 24 as being at housed in a container or cassette or cartridge 26. The term “cartridge” is used herein to mean any housing or structure which defines a volume substantially occupied by the media 24 and which also serves to shelter the media 24. The cartridge 26 typically has a lid 28 or access port which can be opened and through which media 24 is extracted in conjunction with performance of transducing operations (writing information to media or reading information from media 24) by drive 20. FIG. 1 shows by broken lines the segments of media 24 which remain in (e.g., are sheltered by) cartridge 26. Segments of media 24 which are exposed are shown by a solid line, it being noted that in FIG. 1 the lid 28 of cartridge 26 is open.

The information transducing drive can be a magnetic tape drive, for example. In the illustrated embodiment of FIG. 1, for sake of representative an example tape drive 20 is depicted as a generic helical scan tape drive which transduces information on/from media 24 in the form of magnetic tape. In the non-limiting embodiments in which the information transducing drive takes the form of a magnetic tape drive, it is not confined or limited to any particularly type of magnetic tape drive but instead can take myriad forms, such as a magnetic tape drive that formats information in linear stripe (e.g., serpentine pattern) or in a helical stripe pattern, and the magnetic tape media can have any of numerous types of composition and dimensional aspects.

Drive 20 comprises information transducer 30; cartridge handler 32; media transport controller 34; and controller 36. The transducer 30 performs the information transducing operations with respect to media 24, and The can take the form of any transducing device such as those commonly known as a “head” which employs one or more “gaps” or magneto-restrictive elements (“transducing elements”) to transducer (e.g., write or read) information with respect to (e.g., to or from) the media. Cartridge handler 32 opens lid 28 of cartridge 26 and selectively extracts media 24 at least partially from cartridge 26 in conjunction with a transducing operation and then selectively retracts media 24 into cartridge 26 and closes the lid 28 upon cessation of use of cartridge 26. The media transport controller 34, together with other components comprising a media path, comprise media transport system 35. The media transport system 35 transports the media extracted from cartridge 26 in a transport path whereby the transducer 30 can perform the information transducing operations with respect to the media 24.

The controller 36 essentially coordinates all operational aspects of the drive, both of elements already described and yet described. In doing so, controller 36 executes coded program instructions which are stored in program memory 38. The program memory 38 can take any form, including that of a read only memory (ROM) or a semiconductor memory, for example. The controller 36 and other controllers or processors describe herein can comprise a programmed processor or controller which executes coded instructions stored on a program media, or alternatively or additionally can comprise a hardware circuit or firmware for performing essentially the same functions. Further, the controllers and processors described herein can be dedicated processors or shared processors. Moreover, the functionalities of the controllers or processors described herein can be distributed among plural controllers or processors, if desired.

Of particular interest herein is the fact that program memory 38 includes a software program product 40 that enables controller 36 to execute a media preservation mode (MPM). As explained herein, in executing a media preservation mode of the software program product 40 the controller 36 directs return of the information transducable media 24 to the cartridge 26 whereby substantially all user data eligible segments of the media are unexposed while the drive appears on-line with respect to further transducing operations (e.g., subsequent potential transducing operations). Controller 36 also has access to data memory 42, which can take the form of a RAM, for example.

Drive 20 further comprises host interface 44 (which is connected via interface bus 23 to host device 22) and buffer manager 46. Data bus 48 connects host interface 44 to buffer manager 46. Both host interface 44 and buffer manager 46 are connected by bus system 50 to main controller 36. Buffer manager 46 controls, e.g., both storage of user data in data buffer memory 52 and retrieval of user data from buffer memory 52. User data is data from host 22 intended for recording on media 24 (in a recording or write operation) or data stored on media 24 that is destined from media 24 to host 22 (in a reproduction or read operation).

Buffer manager 46 is also connected to track pattern write section 54 and track pattern read section 56. The track pattern write section 54 comprises formatter/encoders 60 which is/are connected to write channel(s) 62. The track pattern read section 56 comprises deformatter/decoders 64 which is/are connected to read channel(s) 66.

The information transducer 30 comprises one or more heads which are mounted on a transducer-carrying structure. For the representative helical scan magnetic tape drive illustrated in FIG. 1, the transducer-carrying structure comprises a rotatable scanner or drum 70. The drum 70 has an essentially cylindrical shape and has the one or more heads mounted on a peripheral surface of drum 70. The heads comprising information transducer 30 are situated on the periphery of drum 70, and the path of media 24 about the peripheral surface of drum 70 is such that the heads of drum 70 travel over helical striped paths on media 24. Although information transducer 30 is shown in FIG. 1 as being situated at one peripheral location, it will be appreciated that (in some embodiments) plural heads can comprise information transducer 30, and that those plural heads may be located at different peripheral positions on drum 70, e.g., at different angular positions about the axis of drum 70. Each head may comprise one or more transducing elements or gaps. Each write channel 62 is connected to a corresponding write transducing element which comprises a head of information transducer 30; each read channel(s) 66 is connected to a corresponding read transducing element which comprises a head of information transducer 30. In addition to write transducing elements and read transducing elements, drum 70 can also have certain unillustrated electronics mounted thereon.

As mentioned previously, media 24 is wrapped around drum 70 such that aforementioned transducing elements follow helical stripes on media 24 as media 24 is transported in a direction indicated by arrow 72 from supply reel 76 to take-up reel 78. Supply reel 76 and take-up reel 78 are typically housed in cartridge 26 from which media 24 is extracted into a media path that includes wrapping around drum 70. The media path also is at least partially defined by plural media guide members 80 which, like drum 70, are mounted on a deck of the drive 20. The nature, number, and placement of media guide members 80 depends in the various embodiments upon the desired configuration of the media path, the desired wrap angle of the media about drum 70, the type of tension control exercised on media 24 in the media path, and whether the media guide members 80 are active (driven to impart motion to media 24) or are passive. Typically the media guide members 80 comprise rollers which can either active or passive, stationary or tensioned.

In one embodiment, a supply reel 76 and take-up reel 78 are driven by supply reel motor 82 and take-up reel motor 84, respectively, to transport media 24 in the direction 87 during a normal read or write operation. In a rewind operation the direction of media is opposite that of arrow 87. Reel motors 82 and 84 are driven by media transport controller 34, which ultimately is governed by main controller 36. The media guide members 80, together with the media transport controller 34 and the reel motors 82 and 84, comprise the media transport system 35 for an example embodiment. Operation and control of the media transport system of this representative type of drive including reel motors 82 and 84 is understood by the person skilled in the art with reference, for example, to U.S. Pat. No. 5,680,269 and incorporated herein by reference. It will be appreciated that in other example embodiments, the media transport system 35 can comprise different elements, such as a capstan, for example, and may not have either or both of supply reel 76 and take-up reel 78 as being driven.

As stated previously, controller 36 executes software program product 40 which enables controller 36 to execute the aforementioned media preservation mode (MPM). As explained herein, in executing the software program product 40 the controller 36 directs return of the information transducable media 24 to the cartridge 26 whereby substantially all user data eligible segments of the media are unexposed while the drive 20 appears on-line with respect to further transducing operations.

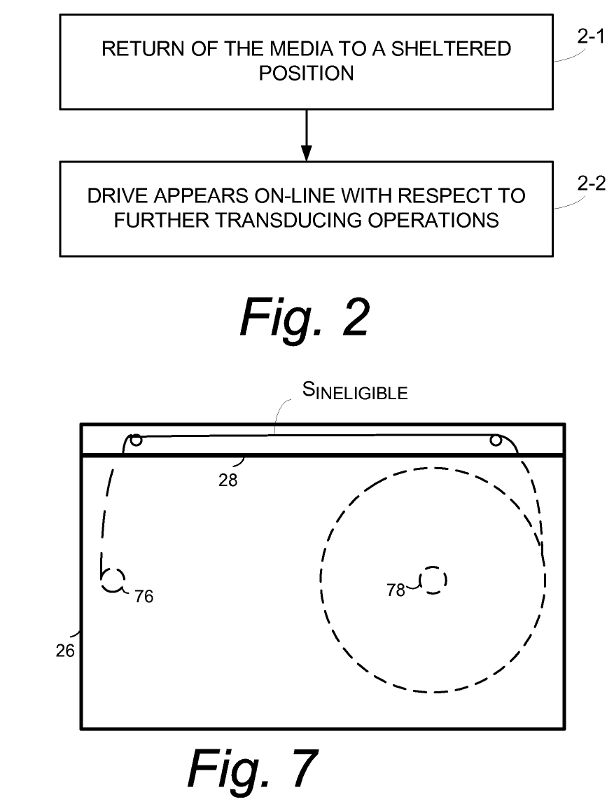

FIG. 2 thus represents basic aspects of the media preservation mode, with symbol 2-1 illustrating return of the information transducable media 24 to a sheltered position (e.g., in the cartridge 26) while symbol 2-2 illustrates the fact that drive 20 appears on-line with respect to further transducing operations.

The media preservation mode can be performed by or initiated by controller 36 upon any suitable triggering event, such as (for example) when drive 20 has been left quiesced for a predetermined period of time (e.g., no recording or reproducing operations prompted or requested by host device 22 served by the information transducing drive 20). In an example implementation, controller 36 determines that/when the media preservation mode should commence. Such detection can comprise determining time elapsed since a last transducing operation command issued by host device 22.

In being “unexposed” is meant that recording/reproducing surfaces of the segments of media 24 are shelter or covered, e.g., by other layers of media (wrapped on reels or in a pack, in the case of the media being magnetic tape, for example) or by cartridge 26, etc., and thereby sheltered from potential contaminates.

By drive 20 appearing on-line with respect to further transducing operations means that host device 22, and thus host interface 44, is essentially oblivious to execution of the media preservation mode. That is, no information indicative of the execution of the media preservation mode is transmitted through host interface 44.

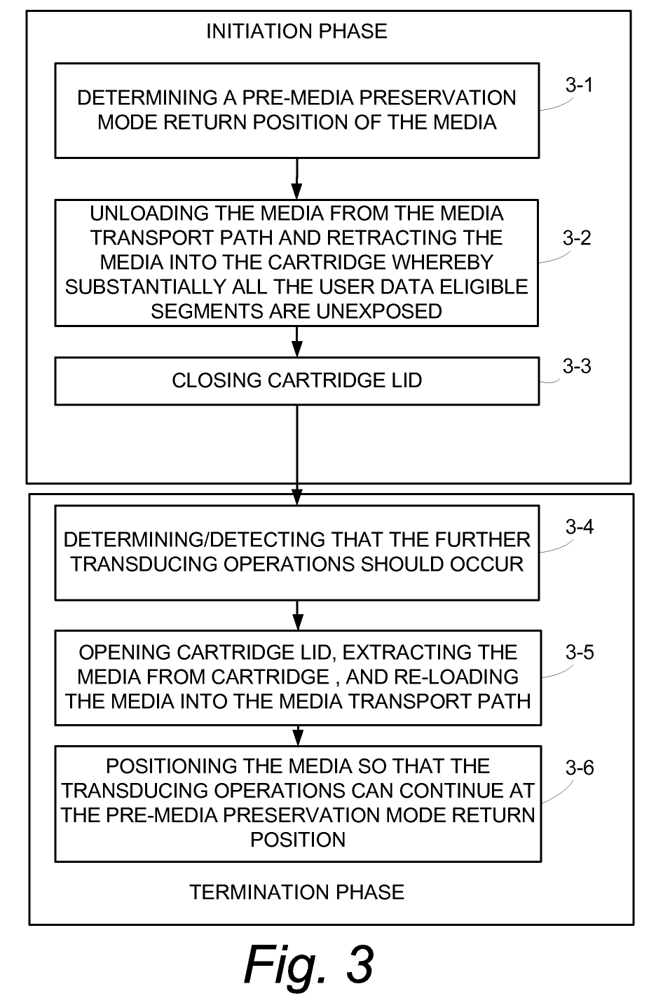

Example acts or steps of a first example embodiment of the media preservation mode is shown in FIG. 3. In the example embodiment of FIG. 3, media preservation mode is shown as comprising an initiation phase, a termination phase, and an interruption phase.

The initiation phase serves for sheltering or covering substantially all the user data eligible segments of the media. The initiation phase is commenced at an appropriate time, such as when the drive has been left quiesced for a predetermined period of time (e.g., when a host or user device connected to the information transducing drive has not issued a transducing command [e.g., for reproducing from the media or recording to the media] for a predetermined period of time). The termination phase of the media preservation mode serves for returning the media to an appropriate transducable position when controller 36 realizes that the host device 22 has or is ready to issue another transducing command. If, in the course of performing the initiation phase, controller 36 realizes before completion of the initiation phase that the host or user device has or is ready to issue another transducing command, the media preservation mode can switch to the interruption phase.

In the example embodiment of FIG. 3, the initiation phase of the media preservation mode comprises, as act 3-1, determining a pre-media preservation mode return position of the media. In an example implementation, controller 36 determines the pre-media preservation mode return position. The pre-media preservation mode return position is a physical position of the media eligible for a post-media preservation mode transducing operation.

Act 3-2 of the initiation phase comprises unloading the media from the media transport path and retracting the media into the cartridge whereby substantially all the user data eligible segments are physically within cartridge 26 and are sheltered (e.g., unexposed). Act 3-2 can be performed under direction of controller 36, e.g., controller 36 directing the cartridge handler 32 to unload the media from the media transport path and to retract the media into the cartridge 26 whereby substantially all the user data eligible segments are sheltered (e.g., unexposed). Act 3-3 of the initiation phase comprises the cartridge handler 32 closing the lid 28 of the cartridge 26.

In the example embodiment of FIG. 3, the termination phase of the media preservation mode comprises returning the media to an appropriate transducable position when controller 36 realizes that the host or user device has or is ready to issue another transducing command. Actions included in the termination phase include act 3-4 through act 3-6 shown in FIG. 3.

Act 3-4 of the termination phase of the media preservation mode comprises determining/detecting that the further transducing operations should occur. Act 3-5 comprises opening lid 28 of cartridge 26; extracting the media from cartridge 26; and, re-loading the media into the media transport path. Act 3-5 can be performed by directing the cartridge handler 32 to open lid 28; to extract the media from the cartridge 26; and, to re-load the media into the media transport path. Act 3-6 comprises positioning the media so that the transducing operations can continue at the pre-media preservation mode return position. Act 3-6 can be performed by directing the media transport system 35 to properly re-position the media so that the transducing operations can continue at the pre-media preservation mode return position.

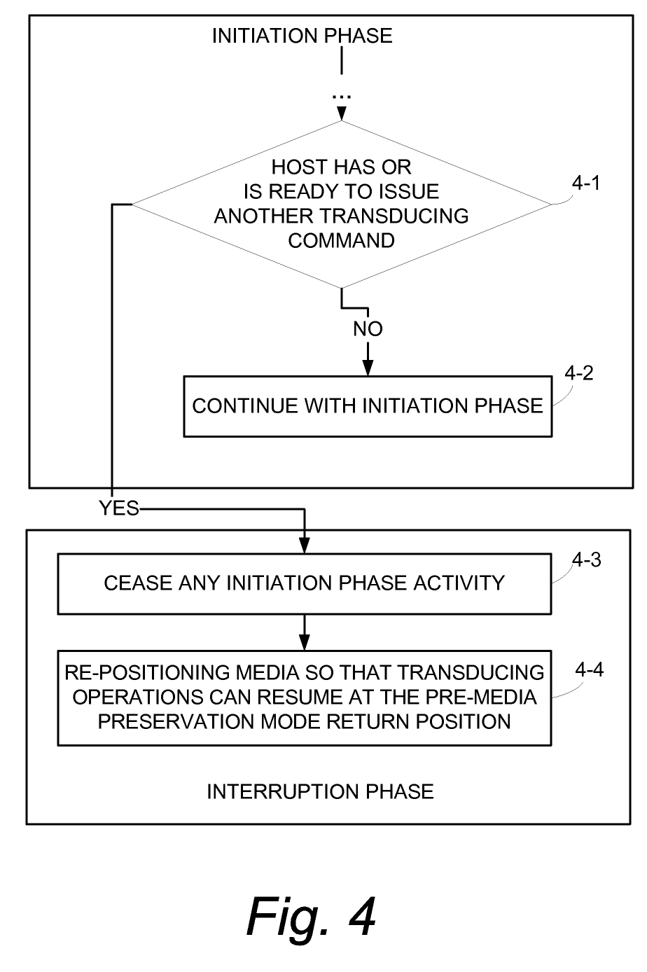

If, in the course of performing the initiation phase, controller 36 realizes before completion of the initiation phase that the host or user device has or is ready to issue another transducing command, the media preservation mode can switch to its interruption phase. FIG. 4 shows, as act 4-1, the controller 36 determining whether host or user device has or is ready to issue another transducing command. The arrow leading to the symbol for act 4-1 is intended to reflect the fact that the determination of act 4-1 can occur essentially at any point during the initiation phase. Determining whether host or user device has or is ready to issue another transducing command can comprise, for example, receiving an interrupt from host device 22 or from host interface 44.

FIG. 4 further reflects the fact that the interruption phase of the media preservation mode is invoked when controller 36 detects or realizes that, before completion of the initiation phase, the host or user device has or is ready to issue another transducing command. If, as reflected by the negative branch of the symbol for act 4-1, controller 36 does not determine or realize that further transducing operations should occur, as act 4-2 the activities of the initiation phase continue (e.g., the activities of act 3-1, act 3-2 (optional), and act 3-3 of FIG. 3, for example). Otherwise, if (as reflected by the positive branch of the symbol for act 4-1) controller 36 determines or realizes that further transducing operations should occur, the interruption phase of FIG. 4 is entered.

The interruption phase comprises, as act 4-3, ceasing any current initiation phase activity and (as act 4-4) re-positioning the media so that the transducing operations can continue at the pre-media preservation mode return position. For example, act 4-4 of the interruption phase can comprise controller 36 directing the media transport system to position the media so that the transducing operations can continue at the pre-media preservation mode return position.

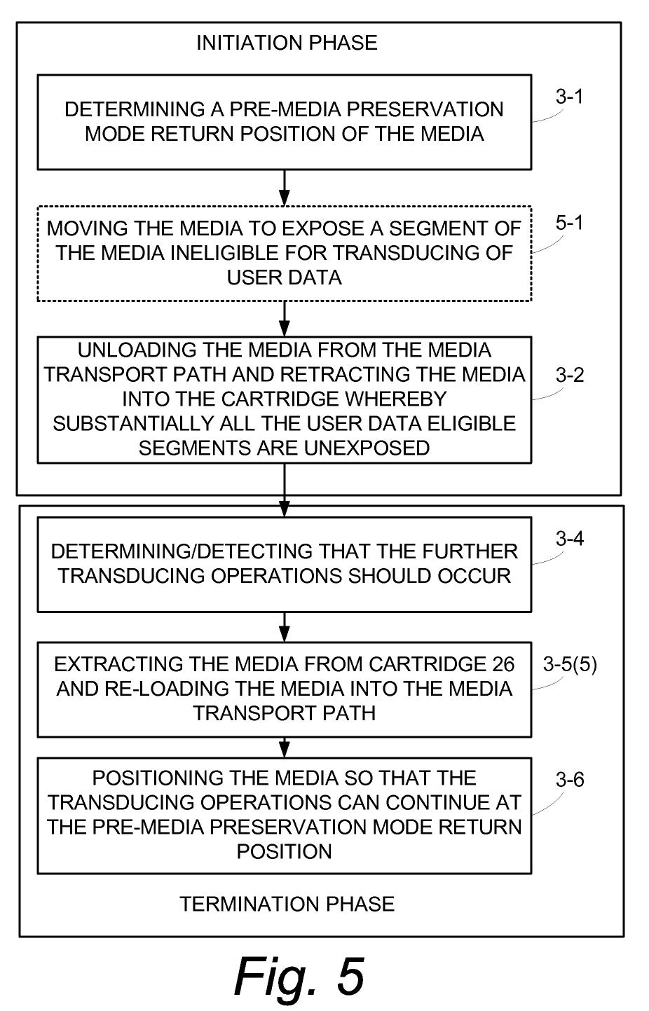

FIG. 5 shows a variation of the initiation phase of the example embodiment of FIG. 3. In the variation of FIG. 5, in the initiation phase the controller 36 directs the return of the media to the cartridge 26, but the lid 28 of cartridge 26 is not closed after retraction of media from the media path of the drive. As such, only a segment of the media is exposed through lid 28 of cartridge 26. However, the segment of the media that is exposed through lid 28 of cartridge 26 is a segment of the media which is ineligible for transducing of user data. Preferably, the segment of the media ineligible for user data comprises a predetermined portion of the media proximate one of a physical beginning of the media (PBOM) and a physical end of the media (PEOM).

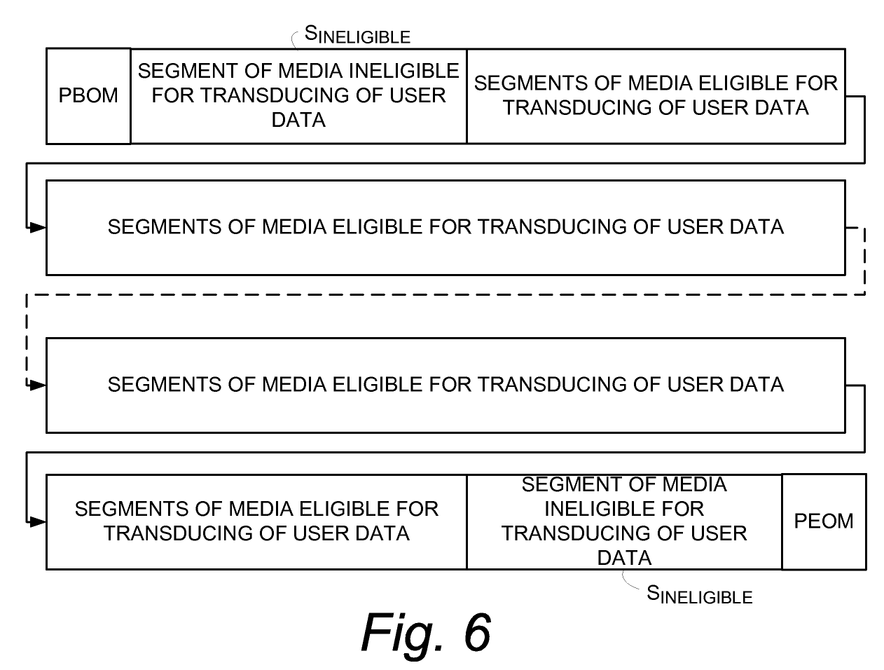

FIG. 6 shows an example format of a representative media 24 suitable for illustrating various segments of the media. FIG. 6 particularly shows that the segments of the media ineligible for user data can be, for example, a predetermined portion of the media proximate one of a physical beginning of the media (PBOM) and a physical end of the media (PEOM). FIG. 6 also shows segments of the media which are eligible for transducing of user data. FIG. 7 shows cartridge 26 having its lid 28 open and thereby exposing a segment of media (S_{INELIGBILE}) which is ineligible for transducing of user data. In FIG. 7, media which is non-exposed or sheltered by cartridge 26 is shown by broken lines, whereas the exposed segment of media (S_{INELIGBILE}) which is ineligible for transducing of user data is shown by a solid line.

As in the embodiment of FIG. 3, act 3-1 of the initiation phase of the media preservation mode of FIG. 5 comprises determining a pre-media preservation mode return position of the media. But act 5-1 of FIG. 5, which follows act 3-1, comprises moving the media to expose a segment of the media ineligible for transducing of user data (e.g., segment of media (S_{INELIGBILE}) as shown in FIG. 7). In an example implementation, controller 36 directs the media transport system 35 to move the media 24 to expose the segment of the media that is ineligible for transducing of user data. Other acts of the FIG. 5 variation of the FIG. 3 embodiment are essentially the same as those of FIG. 3, with the exception the FIG. 5 variation does not include act 3-3 (i.e., lid 28 of cartridge 26 is not closed) and with the further exception that act 3-5(5) of FIG. 5 does not include opening lid 28 of cartridge 26 (since the lid 28 was not closed but remained open).

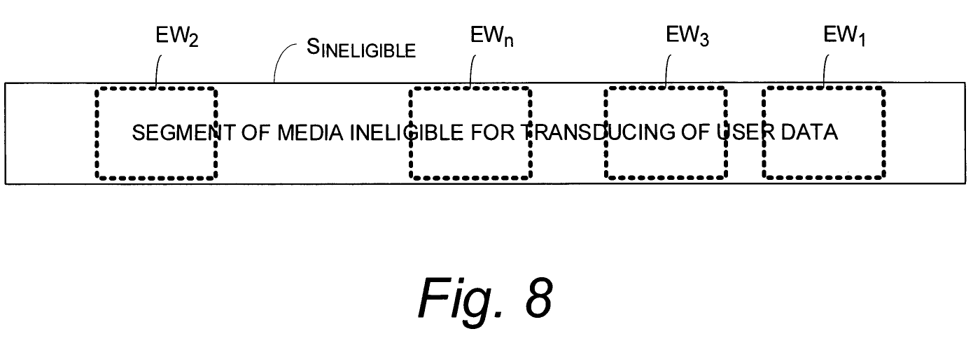

In an example implementation of the variation of FIG. 5, controller 36 directs the media transport system to move the media to expose a random portion of the segment of the media ineligible for transducing of user data. The operation that reflects this random exposure variation is illustrated in FIG. 8, which shows (not to scale) different exposure windows (EW₁-EWₙ) of the segment of the media ineligible for transducing of user data. For example, during a first occasion of the media preservation mode the exposure window EW₁ of the segment of media (S_{INELIGBILE}) may be exposed in the manner shown in FIG. 7, while in a second occasion of the media preservation mode the exposure window EW₂ of the segment of media (S_{INELIGBILE}) may be exposed, and so forth. Advantageously, during other (e.g., subsequent) possible executions of the media preservation mode, numerous positions (exposure windows) of the ineligible segment are exposed so that no particular position on the ineligible segment becomes repeatedly exposed to potential contaminates.

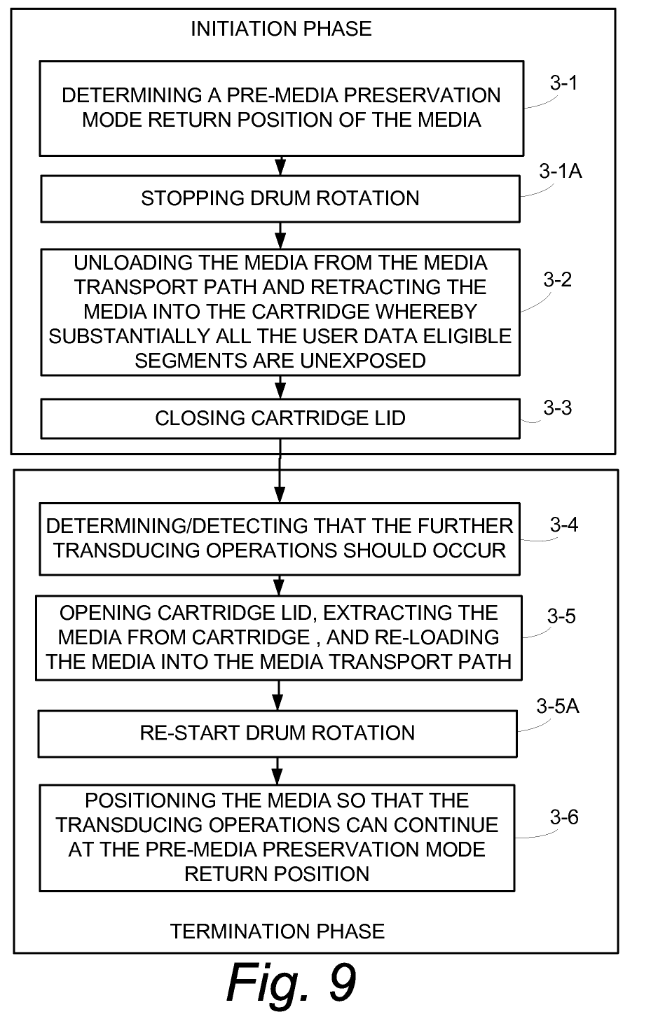

In an example embodiment, such as that illustrated in FIG. 1, the information transducing drive 20 comprises a rotating drum (such as drum 70 in FIG. 1) upon which information transducer 30 is mounted. The drum can be a rotating “scanner” or “rotor” as employed in a helical scan information transducing drive, for example. In such drum embodiment, controller 36 can, in conjunction with the media preservation mode, stop rotation of the drum in the initiation phase and then re-start rotation of the drum during the termination phase. The controller 36 can stop and re-start rotation of drum 70 by sending appropriate signals to an unillustrated drum motor. FIG. 9 shows a variation of the acts of the media preservation mode which can be performed for an information transducing drive which employs such a rotatable drum. The acts of the FIG. 9 variation are essentially the same as those of FIG. 3, with the exception the FIG. 9 variation includes, in its initiation phase, the further act 3-1A of stopping rotation of the drum, and in its termination phase, further act 3-5A of re-starting rotation of the drum. The precise sequence of acts of FIG. 9 including the act of stopping drum rotation and the act of re-starting need not necessarily be as shown in FIG. 9, as in some drives it may be preferable to stop or re-start the drum at other times in the respective phases.

In another one of its aspects the technology concerns a software program product comprising coded instructions stored on a program media. When executed by a processor of a drive which performs information transducing operations with respect to transducable media, the software program product directs return of the transducable media to a cartridge whereby substantially all user data eligible segments of the media are unexposed or sheltered while the drive appears on-line with respect to further transducing operations. In its various implementations, the software program product can facilitate the example embodiments and implementations described above.

Some types of magnetic tape (such as that used by the VXA drive) have a logical format which provides for ½ meter of unused tape at both physical beginning of tape (PBOT) and physical end of tape (PEOT). In accordance with an example embodiment, when the firmware (e.g., controller 36) detects that the drive has been left quiesced (no outstanding host/user requests active) for a fixed duration (e.g., 30 minutes), the drive enters the media preservation mode (MPM) in an attempt to shelter the media from contaminates, as described below with particular emphasis upon a tape drive in which the cartridge lid is not closed during the media preservation mode (and which is one, non-limiting example of a information transducing drive suitable for implementing the media preservation mode).

When the Media Preservation Mode (MPM) is required, the following acts are performed:

1) Retain the physical return position (tape count) and physically move to PEOT (physical end of tape).

2) Once at PEOT, randomly position to a location within the ½ meters of unused tape at the PEOT.

3) Once positioned, unload the tape path and stage down (drum off, servos off).

In conjunction with Media Preservation Mode (MPM), the drive remains at rest until action is required (next host/user request requiring tape motion). During Media Preservation Mode (MPM) at rest, the tape is retracted back into the case (with lid open) with only the minimal amount of media being exposed. Furthermore, the media which is exposed on not over any critical customer data region (the exposed potion of the media can be, for example, the dedicated ½ meters of unload area at PEOT).

When MPM is over, the drive performs the following acts:

1) Energize the system (drum, servo) and load the tape path.

2) Physically move back to the retained return position.

3) Once positioned, honor the host/user request.

When the drive is actively in Media Preservation Mode (MPM), the system appears on-line to the host/user. When coming out of Media Preservation Mode (MPM), all of the Media Preservation Mode (MPM)-related motions are hidden beneath the host/user request which initiated the exit. To the host/user, this simply appears like a longer duration request (e.g., worst case 3 minutes extra). In the event that the host/user interrupts Media Preservation Mode (MPM) on its way to PEOT, all motion will stop with the tape being positioned back to where it originated from (once again, seemless from a host/user perspective). Another benefit of having MPM park in the ½ meter at PEOT is that the amount of tape passed over the heads during our transition into and out of MPM is maximized, essentially utilizing the users media for cleaning purposes.

The foregoing acts of the Media Preservation Mode (MPM) can be initiated and implemented using a processor or controller of the drive. As employed herein, a “processor” or “controller” may be provided through the use of dedicated hardware as well as hardware capable of executing software in association with appropriate software. When provided by a processor, the functions may be provided by a single dedicated processor, by a single shared processor, or by a plurality of individual processors, some of which may be shared or distributed. Moreover, explicit use of the term “processor” or “controller” should not be construed to refer exclusively to hardware capable of executing software, and may include, without limitation, digital signal processor (DSP) hardware, read only memory (ROM) for storing software, random access memory (RAM), and non-volatile storage.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A drive which performs information transducing operations with respect to transducable media, the drive comprising:
a transducer configured to perform the information transducing operations with respect to the media;
a cartridge handler configured to open a lid of a cartridge and to selectively extract the media at least partially from the cartridge and to selectively retract the media into the cartridge;
a media transport system configured to transport the media extracted from the cartridge in a transport path whereby the transducer can perform the information transducing operations with respect to the media;
a controller configured to execute a media preservation mode by directing return of the media to the cartridge whereby substantially all user data eligible segments of the media are sheltered while the drive appears on-line with respect to further transducing operations.

2. The apparatus of claim 1, wherein the controller is configured to execute the media preservation mode by directing the return of the media to the cartridge whereby only a segment of the media ineligible for transducing of user data is exposed.

3. The apparatus of claim 2, wherein the segment of the media ineligible for user data comprises a predetermined portion of the media proximate one of a physical beginning of the media and a physical end of the media.

4. The apparatus of claim 1, wherein the controller is further configured determine that the media preservation mode should commence.

5. The apparatus of claim 1, further comprising an interface through which a command for transducing operations is received, and wherein the interface is essentially oblivious to execution of the media preservation mode.

6. The apparatus of claim 1, wherein the controller is further configured to initiate the media preservation mode by:
determining a pre-media preservation mode return position of the media, the pre-media preservation mode return position being a physical position of the media eligible for a post-media preservation mode transducing operation;
directing the cartridge handler to unload the media from the media transport path and to retract the media into the cartridge whereby substantially all the user data eligible segments are sheltered.

7. The apparatus of claim 6, wherein the controller is further configured to
direct the media transport system to move the media to expose the segment of the media ineligible for transducing of user data;
direct the cartridge handler to unload the media from the media transport path and to retract the media into the cartridge whereby essentially only a segment of the media ineligible for transducing of user data is exposed.

8. The apparatus of claim 7, wherein the segment of the media ineligible for user data comprises a predetermined portion of the media proximate one of a physical beginning of the media and a physical end of the media.

9. The apparatus of claim 7, wherein the controller is further configured to direct the media transport system to move the media to expose a random portion of the segment of the media ineligible for transducing of user data.

10. The apparatus of claim 6, further comprising a drum upon which the transducer is mounted, and wherein the controller is further configured to initiate the media preservation mode by terminating rotation of the drum.

11. The apparatus of claim 6, wherein the controller is further configured to interrupt execution of the media preservation mode by directing the media transport system to position the media so that the transducing operations can continue at the pre-media preservation mode return position if the controller determines that the further transducing operations should occur before the media is retracted into the cartridge.

12. The apparatus of claim 6, wherein the controller is further configured to terminate the media preservation mode by:
determining that the further transducing operations should occur;
directing the cartridge handler to extract the media from the cartridge and to re-load the media into the media transport path;
directing the media transport system to position the media so that the transducing operations can continue at the pre-media preservation mode return position.

13. A software program product comprising coded instructions stored on a program media which, when executed by a processor of a drive which performs information transducing operations with respect to transducable media, directs return of the transducable media to a cartridge whereby substantially all user data eligible segments of the media are sheltered while the drive appears on-line with respect to further transducing operations.

14. The software program of claim 13, wherein execution of the coded instructions performs the further act of directing the return of the media to the cartridge whereby only a segment of the media ineligible for transducing of user data is exposed.

15. The software program of claim 14, wherein the segment of the media ineligible for user data comprises a predetermined portion of the media proximate one of a physical beginning of the media and a physical end of the media.

16. The software program of claim 13, wherein execution of the coded instructions performs the further act of rendering an interface through which a command for transducing operations is received essentially oblivious to execution of the media preservation mode.

17. The software program of claim 13, wherein execution of the coded instructions performs the further acts of initiating the media preservation mode by:
determining a pre-media preservation mode return position of the media, the pre-media preservation mode return position being a physical position of the media eligible for a post-media preservation mode transducing operation;
directing the cartridge handler to unload the media from the media transport path and to retract the media into the cartridge whereby substantially all the user data eligible segments are unexposed.

18. The software program of claim 17, wherein execution of the coded instructions performs the further acts of:
directing the media transport system to move the media to expose the segment of the media ineligible for transducing of user data;
directing the cartridge handler to unload the media from the media transport path and to retract the media into the cartridge whereby essentially only a segment of the media ineligible for transducing of user data is exposed.

19. The software program of claim 18, wherein execution of the coded instructions performs the further act of directing the media transport system to move the media to expose a random portion of the segment of the media ineligible for transducing of user data.

20. The software program of claim 17, wherein execution of the coded instructions performs the further act of terminating rotation of a drum upon which the transducer is mounted.

21. The software program of claim 17, wherein execution of the coded instructions performs the further acts interrupting execution of the media preservation mode by directing the media transport system to position the media so that the transducing operations can continue at the pre-media preservation mode return position if the controller determines that the further transducing operations should occur before the media is retracted into the cartridge.

22. The software program of claim 17, wherein execution of the coded instructions performs the further acts of terminating the media preservation mode by:
determining that the further transducing operations should occur;
directing the cartridge handler to extract the media from the cartridge and to re-load the media into the media transport path;
directing the media transport system to position the media so that the transducing operations can continue at the pre-media preservation mode return position.

23. A method of operating a information transducing drive connected to a host device, the method comprising:
detecting quiescence of transducing commands from the host device; and
returning transducable media to a cartridge whereby substantially all user data eligible segments of the media are sheltered while the drive appears on-line with respect to further transducing operations.

24. The method of claim 23, further comprising returning the media to the cartridge whereby only a segment of the media ineligible for transducing of user data is exposed.

25. The method of claim 23, further comprising rendering an interface through which a command for transducing operations essentially oblivious to execution of the media preservation mode.

26. The method of claim 23, further comprising initiating the media preservation mode by:
determining a pre-media preservation mode return position of the media, the pre-media preservation mode return position being a physical position of the media eligible for a post- media preservation mode transducing operation;
directing the cartridge handler to unload the media from the media transport path and to retract the media into the cartridge whereby substantially all the user data eligible segments are unexposed.

27. The method of claim 26, further comprising:
directing the media transport system to move the media to expose the segment of the media ineligible for transducing of user data;
directing the cartridge handler to unload the media from the media transport path and to retract the media into the cartridge whereby essentially only a segment of the media ineligible for transducing of user data is exposed.

28. The method of claim 27, further comprising moving the media to expose a random portion of the segment of the media ineligible for transducing of user data.

29. The method of claim 26, further comprising terminating rotation of a drum upon which the transducer is mounted.

30. The method of claim 26, further comprising interrupting execution of the media preservation mode by positioning the media so that the transducing operations can continue at the pre-media preservation mode return position if the controller determines that the further transducing operations should occur before the media is retracted into the cartridge.

31. The method of claim 26, further comprising determining that the further transducing operations should occur;
directing the cartridge handler to extract the media from the cartridge and to re-load the media into the media transport path;
directing the media transport system to position the media so that the transducing operations can continue at the pre-media preservation mode return position.
